(19) United States
(12) Patent Application Publication
(10) Pub. No.: US 2025/0191385 A1
(43) Pub. Date: Jun. 12, 2025

(54) ELECTRONIC DEVICE AND METHOD FOR IDENTIFYING CHARACTER STRING OF LICENSE PLATE OF VEHICLE

(71) Applicant: THINKWARE CORPORATION, Seongnam-si (KR)

(72) Inventors: Sukpil Ko, Seongnam-si (KR); Sanghoon Chae, Seongnam-si (KR)

(73) Assignee: THINKWARE CORPORATION, Seongnam-si (KR)

(21) Appl. No.: 18/968,316

(22) Filed: Dec. 4, 2024

(30) Foreign Application Priority Data
Dec. 7, 2023 (KR) 10-2023-0177115

(51) Int. Cl. G06V 20/62; G06T 7/20; G06V 10/25

(52) U.S. Cl. CPC G06V 20/625; G06T 7/20; G06V 10/25; G06V 2201/07

(57) ABSTRACT

According to an embodiment, an electronic device includes at least one camera, communication circuitry, memory, and at least one processor operably connected with the at least one camera, the communication circuitry, and the memory, and the processor is configured to obtain video information through the at least one camera, identify a plurality of images including a designated vehicle based on the video information, identify a designated area corresponding to a license plate of the designated vehicle within the plurality of images, based on the plurality of images, transmit image information on the designated area to a server connected to the electronic device, based on transmitting the image information on the designated area to the server, receive text information on the designated area from the server, and based on the text information, provide a character string represented on the license plate.

### CROSS-REFERENCE TO RELATED APPLICATIONS

This application is based on and claims priority under 35 U.S.C. § 119 to Korean Patent Application No. 10-2023-0177115, filed on Dec. 7, 2023, in the Korean Intellectual Property Office, the disclosure of which is incorporated by reference herein in its entirety.

### BACKGROUND

### Technical Field

The present disclosure relates to an electronic device and a method for identifying a character string of a license plate of a vehicle.

### Description of Related Art

An electronic device mounted on a vehicle to obtain an image with respect to an external environment may be difficult to obtain a clear image due to motion blur generated according to a movement of the vehicle or another vehicle.

The above-described information may be provided as a related art for the purpose of helping to understand the present disclosure. No claim or determination is raised as to whether any of the above-described information may be applied as a prior art related to the present disclosure.

### SUMMARY

According to an embodiment, an electronic device may comprise at least one camera, communication circuitry, memory, and at least one processor operably connected with the at least one camera, the communication circuitry, and the memory, and the processor may be configured to obtain video information through the at least one camera, identify a plurality of images including a designated vehicle based on the video information, identify a designated area corresponding to a license plate of the designated vehicle within the plurality of images, based on the plurality of images, transmit image information on the designated area to a server connected to the electronic device, based on transmitting the image information on the designated area to the server, receive text information on the designated area from the server, and based on the text information, provide a character string represented on the license plate.

According to an embodiment, a method performed by an electronic device may comprise obtaining video information through at least one camera of the electronic device, identifying a plurality of images including a designated vehicle based on the video information, identifying a designated area corresponding to a license plate of the designated vehicle within the plurality of images, based on the plurality of images, transmitting image information on the designated area to a server connected to the electronic device, based on transmitting the image information on the designated area to the server, receiving text information on the designated area from the server, and based on the text information, providing a character string represented on the license plate.

A non-transitory computer readable storage medium may store one or more programs. The one or more programs may comprise instructions which, when executed by at least one processor of an electronic device including at least one camera, communication circuitry, and memory, cause the electronic device to obtain video information through the at least one camera, identify a plurality of images including a designated vehicle based on the video information, identify a designated area corresponding to a license plate of the designated vehicle within the plurality of images, based on the plurality of images, transmit image information on the designated area to a server connected to the electronic device, based on transmitting the image information on the designated area to the server, receive text information on the designated area from the server, and based on the text information, provide a character string represented on the license plate.

According to an embodiment, an electronic device may comprise communication circuitry, memory, and at least one processor operably connected with the communication circuitry and the memory. The processor may be configured to, based on first video information obtained from a first external electronic device disposed at a first location, identify a designated vehicle having a license plate indicating a designated character string, based on the first video information, identify speed information of the designated vehicle, based on the first location, identify at least one external electronic device within a radius identified based on the speed information of the designated vehicle, based on second video information obtained from the at least one external electronic device, identify the designated vehicle having the license plate indicating the designated character string, based on identifying the designated vehicle, identify a second external electronic device obtaining video information including the designated vehicle from among the at least one external electronic device, and based on a second location on which the second external electronic device is disposed and a moment at which the video information including the designated vehicle is obtained, identify a location of the designated vehicle.

### BRIEF DESCRIPTION OF THE DRAWINGS

The above and other aspects, features, and advantages of certain embodiments of the disclosure will be more apparent from the following description, taken in conjunction with the accompanying, in which:

FIG. 1 illustrates an example of an operation of an electronic device that identifies a character string represented on a license plate of a vehicle using an image with respect to the vehicle.

FIG. 2 illustrates an example of a change in an image according to a high dynamic range (HDR) rendering.

FIG. 3 illustrates an example of a block diagram of an electronic device and a server according to an embodiment.

FIG. 4 is an exemplary flowchart for explaining an operation of an electronic device according to an embodiment.

FIG. 5 illustrates an example of an operation of a server using a recognition model according to an embodiment.

FIG. 6 illustrates an example of an operation of an image quality improvement model according to an embodiment.

FIG. 7 illustrates an example of a license plate recognition operation using a recognition model according to an embodiment.

FIG. 8 illustrates an example of a user interface provided through an electronic device according to an embodiment.

FIG. 9A is an exemplary flowchart for explaining an operation of a server according to an embodiment.

FIG. 9B illustrates an example of an operation of a server according to an embodiment.

FIG. 10 illustrates an example of a block diagram illustrating an autonomous driving system of a vehicle according to an embodiment.

FIGS. 11 and 12 illustrate an example of a block diagram illustrating an autonomous moving object according to an embodiment.

FIG. 13 illustrates an example of a gateway associated with a user device according to various embodiments.

FIG. 14 is a block diagram of an electronic device according to an embodiment.

### DETAILED DESCRIPTION

An electronic device according to an embodiment can identify a character string of a license plate of a vehicle based on an image with respect to the vehicle.

Hereinafter, embodiments of the present document will be described with reference to the accompanying drawings. With respect to the description of the drawings, similar reference numerals may be used for similar or related components.

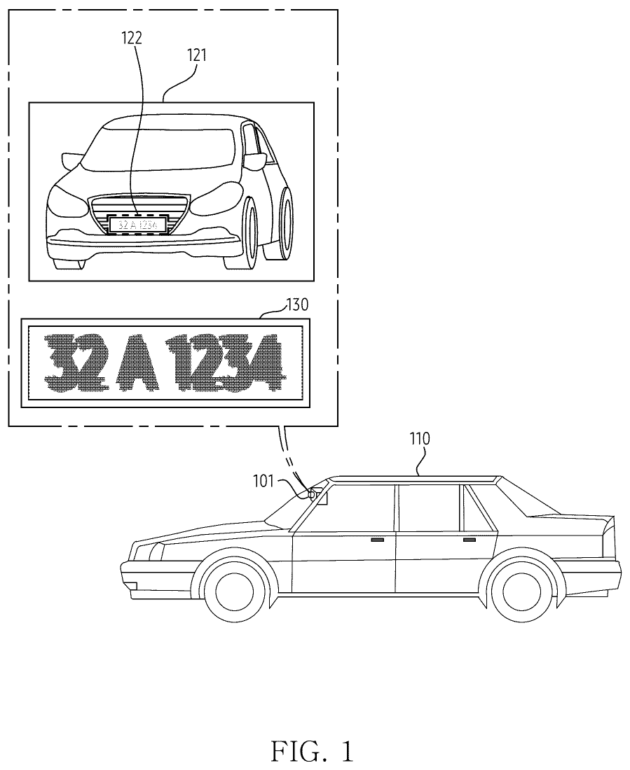

FIG. 1 illustrates an example of an operation of an electronic device that identifies a character string represented on a license plate of a vehicle using an image with respect to the vehicle.

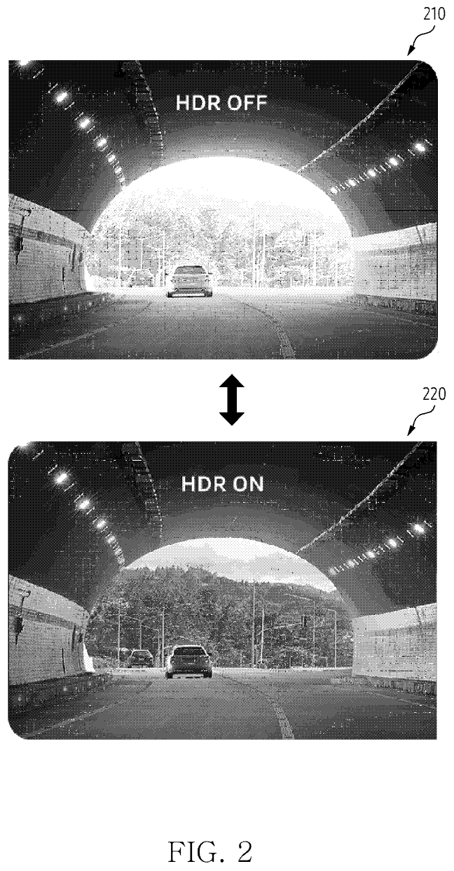

FIG. 2 illustrates an example of a change in an image according to a high dynamic range (HDR) rendering.

Referring to FIG. 1, an electronic device 101 may be included in a vehicle 110. The electronic device 101 may correspond to an electronic control unit (ECU) in the vehicle 110 or may be included in the ECU. The ECU may be referred to as an electronic control module (ECM). The electronic device 101 may be configured as independent hardware for providing a function according to an embodiment of the present invention in the vehicle 110. An embodiment is not limited thereto, and the electronic device 101 may correspond to a device (e.g., a black box) attached to the vehicle 110 or may be included in the device.

The electronic device 101 according to an embodiment may include a camera located toward a direction of the vehicle 110. FIG. 1 illustrates that the electronic device 101 (or the camera included in electronic devices 101) is disposed toward a front direction and/or a driving direction of the vehicle 110, but is not limited thereto. For example, the electronic device 101 may be disposed toward at least one of a rear direction or a side direction of the vehicle 110.

According to an embodiment, the electronic device 101 may obtain an image 121 with respect to an external vehicle through the camera. The electronic device 101 may recognize the external vehicle included in a field-of-view (FoV) of the camera by using the image 121 obtained through the camera. For example, the image 121 with respect to the external vehicle may include an area 122 corresponding to a license plate of the external vehicle. The electronic device 101 may obtain an image 130 in which the area 122 in the image 121 is cropped. The electronic device 101 may identify a character string represented on the license plate of the external vehicle based on the image 130. The character string may not be identified according to at least one of resolution, white noise, or a blur phenomenon of the image 130.

According to an embodiment, the electronic device 101 may perform various methods to obtain a clear image so that the character string represented on the license plate of the external vehicle may be identified.

For example, the electronic device 101 may obtain the clear image (or video) by increasing a performance of a digital video recorder (DVR) included in the electronic device 101. For example, the electronic device 101 may include a DVR having a 4K resolution. The electronic device 101 may obtain the clear image based on the DVR having a high resolution. Even if the DVR has the high resolution, the white noise and/or the blur phenomenon by a rolling shutter method of the camera may occur in a video obtained in an environment where a smear by light or rainwater occurs, an environment where backlighting occurs, or an environment where there is little lighting (e.g., an underground parking lot).

As an example, in the camera of the rolling shutter method, a time at which all pixels between a first pixel and a last pixel are obtained may be different. Accordingly, in the case that the camera or a target object moves, a motion blur phenomenon may occur. In the case that an operation method of the camera included in the electronic device 101 is a global shutter method, the blur phenomenon may be partially prevented, but there is a problem that a price of the camera of the global shutter method is high.

For example, the electronic device 101 may obtain the clear image through the high dynamic range (HDR) rendering. A change in an image according to the HDR rendering will be described with reference to FIG. 2.

Referring to FIG. 2, an image 210 is an image to which the HDR rendering is not applied. An image 220 is an image to which the HDR rendering is applied. The electronic device 101 may obtain the image 220 by synthesizing images according to various exposure values based on the HDR rendering. The electronic device 101 may obtain the clear image even in an environment having a large illuminance difference through the HDR rendering. However, in the case that a dynamic range (DR) is narrow, it may be difficult to identify the character string of the license plate of the external vehicle. In the case that a dynamic range (DR) value is saturated, a visual object corresponding to a small object (e.g., the license plate) may be damaged.

Referring back to FIG. 1, even when performing the above-described exemplary methods, there is a limit to increasing clarity of an image due to a physical limitation of an image sensor. Accordingly, the electronic device 101 may use a server including a recognition model (e.g., an AI model), in order to identify the character string represented on the license plate of the external vehicle through the image 130. For example, the electronic device 101 may transmit the image 130 to the server connected to the electronic device 101. The electronic device 101 may receive text information obtained based on the image 130 from the server. The electronic device 101 may provide the character string represented on the license plate of the external vehicle to a user of the electronic device 101 based on the received text information. As described above, a technical feature for providing the character string represented on the license plate of the external vehicle to the user of the electronic device 101 using the server will be described below.

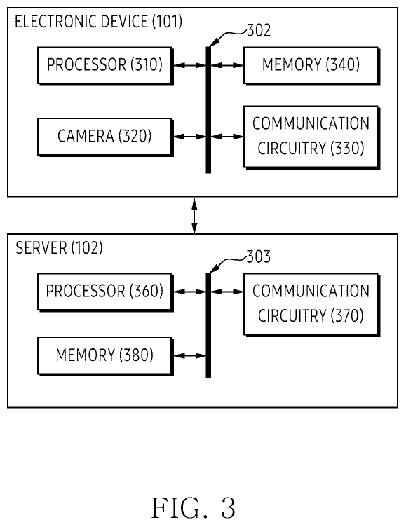

FIG. 3 illustrates an example of a block diagram of an electronic device and a server according to an embodiment. An electronic device 101 of FIG. 3 may correspond to the electronic device 101 of FIG. 1.

Referring to FIG. 3, the electronic device 101 may include at least one of a processor 310, a camera 320, communication circuitry 330, and memory 340. The processor 310, the camera 320, the communication circuitry 330, and the memory 340 may be electronically and/or operably coupled with each other by an electronic component such as a communication bus 302. Hereinafter, devices and/or circuitry being operably coupled may mean that a direct or indirect connection between the devices and/or the circuitry is established by wire or wirelessly, so that second circuitry and/or a second device is controlled by first circuitry and/or a first device. Although illustrated in different blocks, an embodiment is not limited thereto. A portion of hardware of FIG. 3 may be included in a single integrated circuit such as a system on a chip (SoC). A type and/or the number of hardware included in the electronic device 101 is not limited as illustrated in FIG. 3. For example, the electronic device 101 may include only a portion of the hardware illustrated in FIG. 3.

According to an embodiment, the electronic device 101 may include hardware for processing data based on one or more instructions. The hardware for processing data may include the processor 310. For example, the hardware for processing data may include an arithmetic and logic unit (ALU), a floating point unit (FPU), a field programmable gate array (FPGA), a central processing unit (CPU), and/or an application processor (AP). The processor 310 may have a structure of a single-core processor, or may have a structure of a multi-core processor such as a dual core, a quad core, a hexa core, or an octa core.

According to an embodiment, the camera 320 of the electronic device 101 may include a lens assembly or an image sensor. The lens assembly may collect light emitted from a subject that is a target of image capturing. The lens assembly may include one or more lenses. The camera 320 according to an embodiment may include a plurality of lens assemblies. For example, in the camera 320, a portion of the plurality of lens assemblies may have the same lens property (e.g., angle of view, focal length, autofocus, f number, or optical zoom), or at least one of lens assemblies may have one or more lens properties different from lens properties of other lens assemblies. The lens properties may be referred to as an intrinsic parameter for the camera 320. The intrinsic parameters may be stored in the memory 340 of the electronic device 101.

In an embodiment, the lens assembly may include a wide-angle lens or a telephoto lens. According to an embodiment, a flash may include one or more light emitting diodes (e.g., red-green-blue (RGB) LED, white LED, infrared LED, or ultraviolet LED), or a xenon lamp. For example, an image sensor in the camera 320 may obtain an image corresponding to the subject by converting light emitted or reflected from the subject and transmitted through the lens assembly into an electrical signal. According to an embodiment, the image sensor may include, for example, an image sensor selected from among image sensors with different properties, such as an RGB sensor, a black and white (BW) sensor, an IR sensor, or a UV sensor, a plurality of image sensors with the same property, or a plurality of image sensors with different property. Each image sensor included in the image sensor may be implemented, for example, using a charged coupled device (CCD) sensor or a complementary metal oxide semiconductor (CMOS) sensor.

According to an embodiment, the communication circuitry 330 of the electronic device 101 may include a hardware component for supporting transmission and/or reception of an electrical signal between the electronic device 101 and an external electronic device. The communication circuitry 330 may include, for example, at least one of a MODEM, an antenna, and an optic/electronic (O/E) converter. The communication circuitry 330 may support the transmission and/or the reception of the electrical signal, based on various types of protocols such as an ethernet, a local area network (LAN), a wide area network (WAN), wireless fidelity (WiFi), Bluetooth, Bluetooth low energy (BLE), ZigBee, long term evolution (LTE), 5G new radio (NR), and/or 6G.

According to an embodiment, the memory 340 of the electronic device 101 may include a hardware component for storing data and/or instructions inputted and/or outputted to the processor 310 of the electronic device 101. For example, the memory 340 may include volatile memory such as random-access memory (RAM) and/or non-volatile memory such as read-only memory (ROM). For example, the volatile memory may include at least one of dynamic RAM (DRAM), static RAM (SRAM), Cache RAM, and pseudo SRAM (PSRAM). For example, the nonvolatile memory may include at least one of programmable ROM (PROM), erasable PROM (EPROM), electrically erasable PROM (EEPROM), flash memory, a hard disk, a compact disk, a solid state drive (SSD), and an embedded multi-media card (eMMC).

Although not illustrated, the electronic device 101 may further include various components. For example, the electronic device 101 may further include a display for displaying a user interface.

According to an embodiment, the electronic device 101 may be connected to a server 102 using the communication circuitry 330. For example, the server 102 may be used to identify a character string represented on a license plate of a vehicle by processing an image obtained from the electronic device 101.

According to an embodiment, the server 102 may include at least one of a processor 360, communication circuitry 370, or memory 380. The processor 360, the communication circuitry 370, and the memory 380 may be electronically and/or operably coupled with each other by the electronic component such as the communication bus 303. For example, the type and/or the number of hardware included in the server 102 is not limited as illustrated in FIG. 3. For example, the server 102 may include only a portion of the hardware illustrated in FIG. 3. For example, the processor 360 of the server 102 may correspond to the processor 310 of the electronic device 101. The communication circuitry 370 of the server 102 may correspond to the communication circuitry 330 of the electronic device 101. The memory 380 of the server 102 may correspond to the memory 340 of the electronic device 101.

According to an embodiment, the server 102 may include a neural network. For example, the neural network may include a mathematical model for a neural activity of living things associated with reasoning and/or perception, and/or hardware (e.g., CPU, graphic processing unit (GPU), and/or neural processing unit (NPU)) for driving the mathematical model, software, or any combination thereof. The neural network may be based on a convolutional neural network (CNN) and/or long-short term memory (LSTM).

For example, the server 102 (or the memory 380 of the server 102) may include (or store) a recognition model indicated by a plurality of parameters, based on the neural network. The server 102 may obtain text information with respect to the character string represented on the license plate of the vehicle by using the recognition model, based on image information received from the electronic device 101. The server 102 may transmit the text information to the electronic device 101.

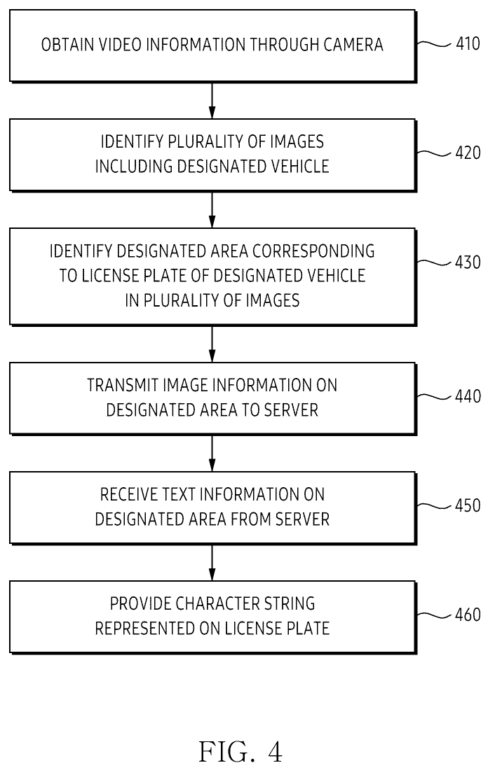

FIG. 4 is an exemplary flowchart for explaining an operation of an electronic device according to an embodiment. The electronic device 101 and/or the processor 310 of FIG. 3 may perform at least one of operations of FIG. 4. In an embodiment, a computer-readable storage medium including a software application and/or instructions that cause the electronic device and/or a processor to perform the operations of FIG. 4, may be provided.

Referring to FIG. 4, in an operation 410, a processor 310 of an electronic device 101 may obtain video information (or video data) through a camera 320 (or at least one camera).

For example, the processor 310 may receive a user input for setting a designated time based on data obtained through the camera 320. The processor 310 may sequentially store data (e.g., the video data) on an external environment through the camera 320. The processor 310 may obtain the video information on the designated time based on the user input for setting the designated time.

According to an embodiment, the processor 310 may provide the video information to a user by using a first program (e.g., a video reproduce program). The processor 310 may display the video information through a display of the electronic device 101.

According to an embodiment, the video information may further include various information in addition to the video data associated with the external environment. For example, the video information may further include at least one of location information of the electronic device 101, speed information of the electronic device 101, acceleration information of the electronic device 101, or path information of the electronic device 101. As an example, a location (or speed, acceleration, path) of the electronic device 101 may correspond to a location (or speed, acceleration, path) of a vehicle (e.g., the vehicle 110) including the electronic device 101.

In an operation 420, the processor 310 may identify a plurality of images including a designated vehicle. For example, the processor 310 may identify the plurality of images including the designated vehicle based on the video information.

For example, the processor 310 may identify an input for selecting the designated vehicle in the video information. Based on the identified input, the processor 310 may track the designated vehicle in the video information. As an example, the processor 310 may identify an input for indicating a vehicle model. As an example, the processor 310 may identify an input for selecting a visual object with respect to the vehicle in the video information.

According to an embodiment, the processor 310 may track the designated vehicle included in the video information through an object detection (OD) model. Based on tracking the designated vehicle included in the video information through the OD model, the processor 310 may identify a plurality of frames including the designated vehicle. The processor 310 may obtain the plurality of images based on the plurality of frames. For example, the processor 310 may identify the plurality of frames as the plurality of images.

In an operation 430, the processor 310 may identify a designated area corresponding to a license plate of the designated vehicle in the plurality of images. The processor 310 may identify the designated area corresponding to the license plate of the designated vehicle in each of the plurality of images.

According to an embodiment, the processor 310 may identify the designated area corresponding to the license plate of the designated vehicle in the plurality of images, based on a color and/or a shape of the license plate. For example, the processor 310 may identify the designated area corresponding to the license plate of the designated vehicle, through a second program for identifying an area for character string identification. For example, the processor 310 may select an image in which the identification of the character string represented on the license plate of the designated vehicle is easy, and then identify the designated area corresponding to the license plate of the designated vehicle in the selected image. According to an embodiment, the image in which the identification of the character string represented on the license plate of the designated vehicle is easy may be selected based on a user input. According to an embodiment, the designated area may be identified based on the user input received from the user.

In an operation 440, the processor 310 may transmit image information on the designated area to a server 102. For example, the processor 310 may transmit the image information on the designated area to the server 102 connected to the electronic device 101 based on the plurality of images.

The processor 310 may obtain images with respect to the designated area in the plurality of images. The processor 310 may obtain the images with respect to the designated area, based on cropping the designated area in the plurality of images. The images with respect to the designated area may correspond to images in which the designated area is cropped from the plurality of images. The processor 310 may obtain the image information on the designated area based on obtaining the images with respect to the designated area. The image information on the designated area may include the images with respect to the designated area.

According to an embodiment, the processor 310 may perform (or execute) an algorithm (or an operation) for identifying (or recognizing) the character string represented on the license plate, based on the designated area corresponding to the license plate. The algorithm may include at least one of an algorithm for improving an image quality of the video (or the image) and/or an algorithm (e.g., an algorithm according to an optical character recognition (OCR) function) for identifying the character string of the image.

The processor 310 may confirm that the identification (or recognition) of the character string according to the algorithm failed. The processor 310 may transmit the image information on the designated area to the server 102, based on the failure of identifying of the character string according to the algorithm. The processor 310 may not transmit the image information on the designated area to the server 102 based on a success of identifying the character string according to the algorithm.

According to an embodiment, the processor 310 may perform the algorithm for identifying the character string represented on the license plate, based on an algorithm stored in the memory 340, and transmit the image information on the designated area to the server 102 only when the identification of the character string fails.

In an operation 450, the processor 310 may receive text information on the designated area from the server 102. For example, based on transmitting the image information on the designated area to the server 102, the processor 310 may receive the text information on the designated area from the server 102.

According to an embodiment, the image information on the designated area may be set as input data of a recognition model indicated by a plurality of parameters included in the server 102. The server 102 may obtain the text information on the designated area based on output data of the recognition model. The text information on the designated area may be obtained based on the output data of the recognition model.

For example, the recognition model included (or stored) in the server 102 may be configured based on a neural network. For example, the recognition model may include at least one of a generative adversarial networks (GAN) model, a residual network (RESnet) model, a nonlinear-activation-free network (NAFnet) model, or a Text-Prior-based Super-resolution model.

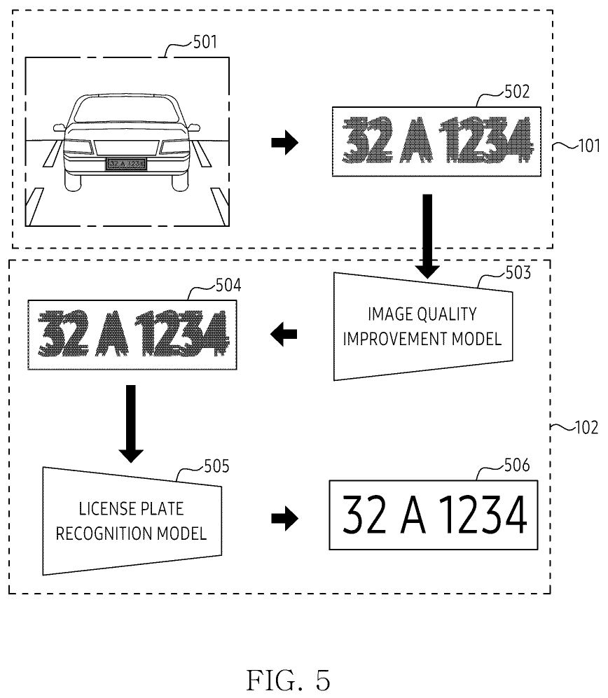

For example, the server 102 may obtain text information based on image information using a recognition model with respect to a third program. For example, in the server 102, an example of a specific operation for obtaining the text information through the recognition model based on the image information will be described later in FIG. 5.

In operation 460, the processor 310 may provide the character string represented on the license plate. For example, the processor 310 may provide the character string represented on the license plate based on the text information.

According to an embodiment, the text information may include candidate strings associated with the character string represented on the license plate, and reliability information on the candidate strings. The processor 310 may identify the candidate strings and the reliability information on the candidate strings, based on the text information. The processor 310 may provide one of the candidate strings as the character string represented on the license plate, based on the reliability information. The processor 310 may provide a candidate character string having the highest reliability as the character string represented on the license plate.

For example, the processor 310 may display the character string represented on the license plate of the designated vehicle, through a user interface displayed using a display (not illustrated) included in the electronic device 101.

FIG. 5 illustrates an example of an operation of a server using a recognition model according to an embodiment.

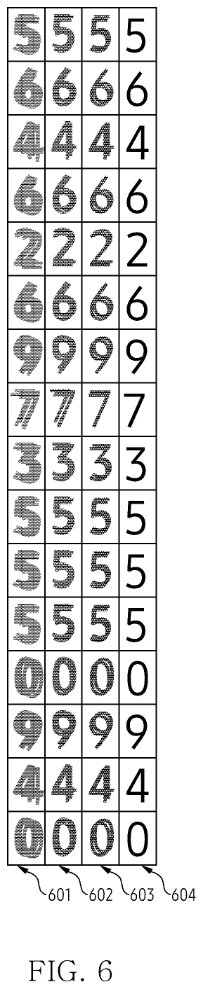

FIG. 6 illustrates an example of an operation of an image quality improvement model according to an embodiment.

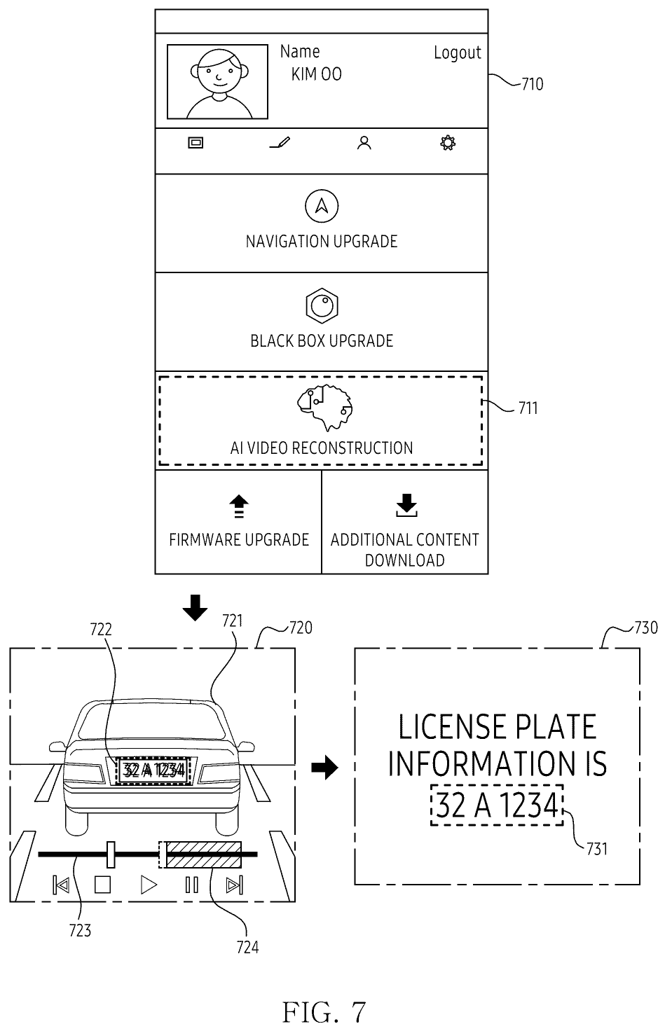

FIG. 7 illustrates an example of a license plate recognition operation using a recognition model according to an embodiment.

Referring to FIG. 5, an electronic device 101 may obtain an image 501. For example, the electronic device 101 may identify the image 501 including a designated vehicle, based on video information obtained through a camera 320. Although FIG. 5 illustrates an example in which an image (e.g., the image 501) is identified for convenience of a description, it is not limited thereto. The electronic device 101 may identify a plurality of images including the designated vehicle.

Based on the image 501, the electronic device 101 may identify an image 502 associated with a designated area. The electronic device 101 may identify the designated area corresponding to a license plate of the vehicle in the image 501 including the designated vehicle. The electronic device 101 may identify (or obtain) the image 502 based on cropping the designated area in the image 501. The image 502 may correspond to the license plate of the designated vehicle.

The electronic device 101 may transmit the image 502 (or image information including the image 502) to a server 102. Herein, a plurality of images may be transmitted to the server 102, and the server 102 may obtain text information on the designated area through a recognition model according to an order in which the transmission of the plurality of images (or image information including the plurality of images) is completed. According to an embodiment, the server 102 may obtain the text information on the designated area through the recognition model according to an order set based on an importance (or priority) of the plurality of images.

The server 102 may set the image 502 as input data of the recognition model. For example, the recognition model may include an image quality improvement model 503 and a license plate recognition model 505.

The server 102 may set the image 502 (or the image information including the image 502) as input data of the image quality improvement model 503. The server 102 may obtain an image 504 based on output data of the image quality improvement model 503. A specific example of learning and execution of the image quality improvement model 503 will be described in FIG. 6.

Referring to FIG. 6, each of images illustrated in FIG. 6 may be used for learning the image quality improvement model 503. For example, images in a first column 601 may be referred to as substandard images. Images in a second column 602 may be referred to as denoised images. Images in a third column 603 may be referred to as reconstructed images. Images in a fourth column 604 may be referred to as ground truth images. The server 102 may train the image quality improvement model 503 based on the images in the first column 601 to the fourth column 604.

For example, the image quality improvement model 503 may be configured based on a GAN model. The server 102 may generate an image in which an image quality is improved based on an inputted image. As an example, a first image (e.g., the image 502 of FIG. 5) similar to the substandard images in the first column 601 may be set as the input data of the image quality improvement model 503. Based on the output data of the image quality improvement model 503, a second image similar to the denoised images in the second column 602 or the reconstructed images in the third column 603 may be obtained.

Referring back to FIG. 5, the server 102 may obtain an image 504 based on the output data of the image quality improvement model 503. The image 504 may be in a state in which an image quality is improved so that a character string is identifiable.

The server 102 may set the image 504 as input data of the license plate recognition model 505. The server 102 may obtain an image 506 based on output data of the license plate recognition model 505. The server 102 may identify the text information based on the image 506. According to an embodiment, the character string may not be recognized through the image 506. The server 102 may identify the character string using a substandard image recognition model (not illustrated) distinguished from the image quality improvement model 503 and the license plate recognition model 505. For example, the server 102 may identify the character string through the substandard image recognition model (not illustrated), based on the image 506 (or the image 504). The substandard image recognition model may be used to estimate the character string based on the image 506 (or the image 504).

According to an embodiment, the text information may include candidate strings and reliability information on the candidate strings. The server 102 may identify (or estimate) the candidate strings based on the image 506. The server 102 may identify the reliability information on the candidate strings. The server 102 may set a reliability value of each of the candidate strings.

The server 102 may transmit the text information to the electronic device 101. The electronic device 101 may obtain the candidate strings and the reliability information on the candidate strings based on the text information. The electronic device 101 may provide the candidate strings to a user, or provide one of the candidate strings identified based on the reliability information to the user.

FIG. 7 illustrates an example of a user interface provided through an electronic device according to an embodiment.

Referring to FIG. 7, a processor 310 of the electronic device 101 may display a screen 710. For example, in the case that the electronic device 101 includes a display (not illustrated), the processor 310 may display the screen 710 including a user interface using the display of the electronic device 101. For example, in the case that the electronic device 101 is connected to an external electronic device including a display, the processor 310 may display the screen 710 including the user interface using the display of the external electronic device.

The screen 710 may include a user interface for managing the electronic device 101. The processor 310 may provide a function for reconstructing a video having a low image quality by using the user interface. The screen 710 may include an object 711 for performing the function for reconstructing the video having the low image quality. The processor 310 may switch the screen 710 to a screen 720, based on identifying an input with respect to the object 711.

The processor 310 may display a video (or data) obtained through a camera 320 on the screen 720. The processor 310 may display the video in the screen 720 by using a program for reproducing the video obtained through the camera 320. For example, the screen 720 may include an indicator 723 for moving time of the video.

The processor 310 may identify a user input for setting a designated time interval. The processor 310 may display an object 724 indicating the designated time interval based on the user input. The processor 310 may display one of frames of the video according to the designated time interval on the screen 720. For example, one of the frames of the video may include a visual object 721 with respect to the vehicle. The visual object 721 with respect to the vehicle may include an area 722 corresponding to the license plate of the vehicle.

According to an embodiment, the processor 310 may identify an input for the visual object 721 in the video according to the designated time interval. The processor 310 may track a vehicle corresponding to the visual object 721 in the video according to the designated time interval. The processor 310 may identify a plurality of frames including the visual object 721 in the video according to the designated time interval. The processor 310 may obtain a plurality of identified frames as the plurality of images. The processor 310 may obtain image information on a designated area by cropping the area 722 corresponding to the license plate of the vehicle in the plurality of images. In the case that the identification of the character string represented on the license plate of the vehicle fails, the processor 310 may transmit the image information to the server 102. The processor 310 may receive text information obtained based on the image information from the server 102.

The processor 310 may switch the screen 720 to a screen 730 based on receiving the text information. The processor 310 may provide a character string 731 represented on the license plate through the screen 730, based on the text information obtained from the server 102.

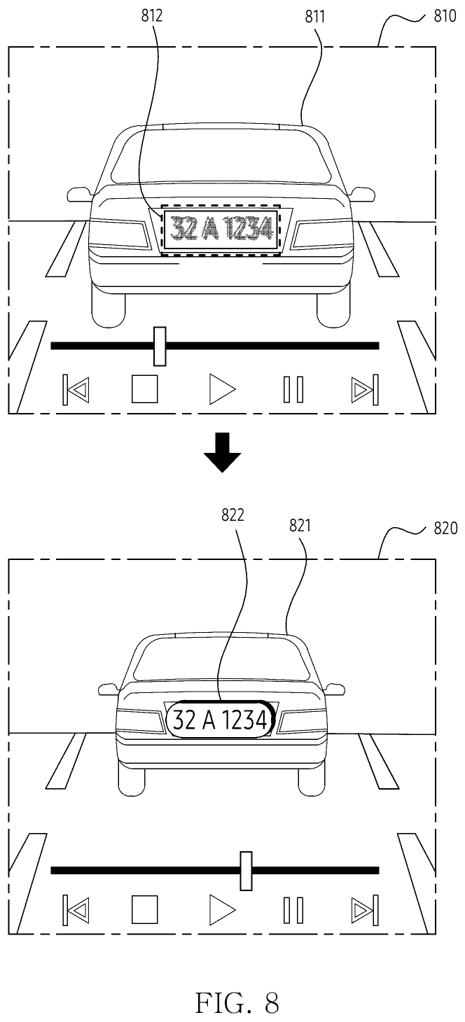

FIG. 8 illustrates an example of a user interface provided through an electronic device according to an embodiment.

Referring to FIG. 8, a processor 310 of an electronic device 101 may display a screen 810. For example, in the case that the electronic device 101 includes a display (not illustrated), the processor 310 may display the screen 810 including a user interface using the display of the electronic device 101. For example, in the case that the electronic device 101 is connected to an external electronic device including a display, the processor 310 may display the screen 810 including a user interface using the display of the external electronic device.

For example, the screen 810 may include a user interface for displaying (or reproducing) a video (or data) obtained through a camera 320. The processor 310 may provide a user interface for performing at least one of reproducing, stop, fast reproducing, capture, or reproducing a time interval when an event occurs, based on the video obtained through the camera 320. For example, the screen 810 may correspond to the screen 720 of FIG. 7.

According to an embodiment, the processor 310 may identify a visual object 811 corresponding to a vehicle in the video while the video obtained through the camera 320 is being displayed (or reproduced) on the screen 810. For example, the processor 310 may identify the visual object 811 corresponding to the vehicle in real time while the video is being reproduced, by using an OD model. The processor 310 may identify an area 812 corresponding to a license plate of the vehicle, based on the visual object 811 corresponding to the vehicle. The processor 310 may identify the area 812 corresponding to the license plate of the vehicle based on a segmentation technique.

Based on the area 812, the processor 310 may perform an algorithm for identifying a character string represented on the license plate of the vehicle. The processor 310 may confirm that the identification of the character string according to the algorithm failed. Based on the failure of the identification of the character string according to the algorithm, the processor 310 may transmit image information with respect to the area 812 to a server 102. The processor 310 may receive text information with respect to the area 812 from the server 102.

Based on receiving the text information with respect to the area 812, the processor 310 may switch the screen 810 to a screen 820. For example, the screen 820 may include a visual object 821 corresponding to the vehicle. The visual object 821 may be distinguished from the visual object 811. The visual object 821 and the visual object 811 indicate the same vehicle, but the visual object 811 may be changed to the visual object 821 as the vehicle moves over time.

The screen 820 may include a visual object 822 corresponding to the license plate of the vehicle. The visual object 822 may be displayed based on the text information received from the server 102. The visual object 822 may include the character string represented on the license plate of the vehicle. While the video is being reproduced, the processor 310 may identify a visual object (e.g., the visual object 811) corresponding to the vehicle in the video, and identify the character string represented on the license plate of the vehicle. While the video is being reproduced, the processor 310 may display the visual object 822 for indicating the character string represented on the license plate of the vehicle by overlapping the visual object 821 corresponding to the vehicle.

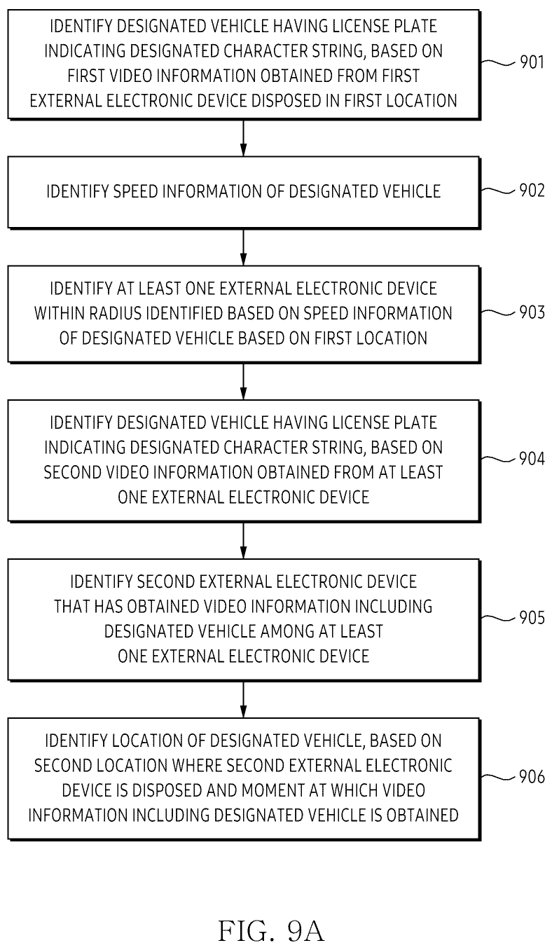

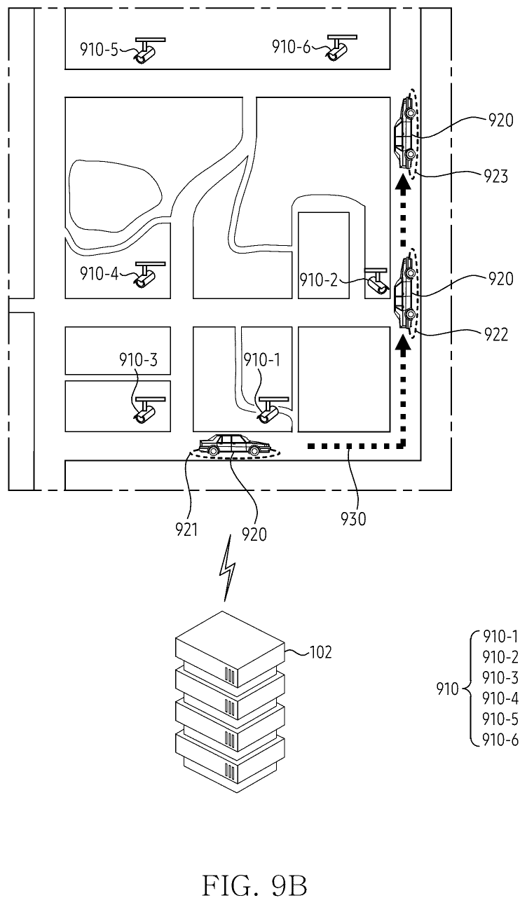

FIG. 9A is an exemplary flowchart for explaining an operation of a server according to an embodiment. The server 102 and/or the processor 360 of FIG. 3 may perform at least one of operations of FIG. 9A. In an embodiment, a computer-readable storage medium including a software application and/or instructions that cause an electronic device and/or a processor to perform the operations of FIG. 9A, may be provided.

Referring to FIG. 9A, in an operation 901, a processor 360 of a server 102 may identify a designated vehicle having a license plate indicating a designated character string, based on first video information obtained from a first external electronic device disposed at a first location.

According to an embodiment, the server 102 may be connected to a plurality of external electronic devices including the first external electronic device. The server 102 may obtain image information (or video information) obtained from the plurality of external electronic devices. The server 102 may receive the image information (or the video information) from the plurality of external electronic devices. Each of the plurality of external electronic devices may be configured to obtain the image information (or the video information) on a different external environment in a different location.

For example, the first external electronic device may be disposed at the first location. The first external electronic device may include a camera for obtaining an image with respect to an external environment in a state of being fixed to the first location. The first external electronic device may be used to identify at least one vehicle included in the external environment. For example, the first external electronic device may include a surveillance camera (e.g., a traffic environment surveillance camera).

The processor 360 may receive a user input indicating the designated character string from a user (or an administrator) of the server 102. The processor 360 may identify the first video information obtained from the first external electronic device, in order to identify the designated vehicle having the license plate indicating the designated character string. In the first video information, the processor 360 may identify the designated vehicle having the license plate indicating the designated character string. In the first video information, the processor 360 may identify a visual object corresponding to the designated vehicle.

In an operation 902, the processor 360 may identify speed information of the designated vehicle. For example, the processor 360 may identify the speed information of the designated vehicle based on the first video information. The processor 360 may identify the speed information of the designated vehicle, based on a first moment at which the designated vehicle (or the visual object corresponding to the designated vehicle) appears in the first video information, a second moment at which the designated vehicle (or the visual object corresponding to the designated vehicle) disappears, and a direction in which the first external electronic device (or the camera of the first external electronic device) is disposed. The processor 360 may identify the speed information of the designated vehicle in order to track a location (or a path) of the designated vehicle.

In an operation 903, the processor 360 may identify at least one external electronic device within a radius identified based on the speed information of the designated vehicle based on the first location. For example, based on the speed information of the designated vehicle, the processor 360 may identify a radius predicted to have moved for a specific time. The processor 360 may identify the at least one external electronic device within the radius identified based on the first location. For example, the processor 360 may identify the at least one external electronic device within the radius identified based on the first location among a plurality of external electronic devices, in order to track the designated vehicle.

In an operation 904, the processor 360 may identify the designated vehicle having the license plate indicating the designated character string, based on second video information obtained from the at least one external electronic device. For example, the processor 360 may receive the second video information including at least one video obtained from each of the at least one external electronic device from the at least one external electronic device. The processor 360 may identify the designated vehicle (the visual object corresponding to the designated vehicle) having the license plate indicating the designated character string among the at least one video included in the second video information.

In an operation 905, the processor 360 may identify a second external electronic device that has obtained video information including the designated vehicle among the at least one external electronic device. For example, the processor 360 may identify the second external electronic device that has obtained the video information including the designated vehicle among the at least one external electronic device, based on identifying the designated vehicle.

According to an embodiment, in order to identify a location where the designated vehicle is moved, the processor 360 may identify the second external electronic device that has obtained the video information including the designated vehicle (or the visual object corresponding to the designated vehicle). The processor 360 may identify that the designated vehicle is moved to a location corresponding to a location of the second external electronic device, based on identifying the second external electronic device.

In an operation 906, the processor 360 may identify a location of the designated vehicle, based on a second location where the second external electronic device is disposed and a moment at which the video information including the designated vehicle is obtained.

For example, the processor 360 may identify the second location where the second external electronic device is disposed. The processor 360 may identify that the designated vehicle is located at a location corresponding to the second location where the second external electronic device is disposed. The processor 360 may identify the moment at which the video information including the designated vehicle is obtained. The processor 360 may identify that the designated vehicle is located at the location corresponding to the second location in the moment at which the video information including the designated vehicle is obtained.

The processor 360 may identify a moving path of the designated vehicle based on identifying the location of the designated vehicle. The processor 360 may identify that the designated vehicle is moved from a location corresponding to the first location to a location corresponding to the second location. The processor 360 may identify the moving path of the designated vehicle, based on identifying that the designated vehicle is moved from the location corresponding to the first location to the location corresponding to the second location.

The processor 360 may predict a current location of the designated vehicle based on the moving path of the designated vehicle. For example, memory 380 may store a path prediction model. The path prediction model may be configured to identify the predicted current location, based on a location change of the designated vehicle. The path prediction model may be configured based on a neural network.

The processor 360 may provide the predicted current location of the designated vehicle to the administrator of the server 102. According to an embodiment, the processor 360 may repeatedly perform the operation 902 to the operation 903, based on identifying the second external electronic device.

FIG. 9B illustrates an example of an operation of a server according to an embodiment.

Referring to FIG. 9B, the server 102 may establish a connection with a plurality of external electronic devices 910. The server 102 (or the processor 360 of the server 102) may obtain a plurality of videos (or video information) from the plurality of external electronic devices 910. The processor 360 may monitor the plurality of videos received from the plurality of external electronic devices 910.

The processor 360 may identify a vehicle 920 having a license plate indicating a designated character string, based on first video information obtained from a first external electronic device 910-1 disposed at a first location. For example, in a first moment, the processor 360 may identify the vehicle 920 based on the first video information obtained from the first external electronic device 910-1 disposed at the first location. Based on the first video information, the processor 360 may identify a location of the vehicle 920 as a location 921 in the first moment.

Based on the first video information, the processor 360 may identify speed information of the vehicle 920 in the first moment. For example, the processor 360 may identify a speed of the vehicle 920, based on identifying a moment at which the vehicle 920 appears and a moment at which the vehicle 920 disappears, in the first video information. The processor 360 may identify a moving direction of the vehicle 920 in the first moment, based on a direction in which the first external electronic device 910-1 is disposed.

The processor 360 may identify at least one external electronic device within a radius identified based on the speed information of the vehicle 920 based on the first location. For example, the processor 360 may identify a second external electronic device 910-2, a third external electronic device 910-3, and a fourth external electronic device 910-4 located within the radius identified based on the speed information of the vehicle 920 based on the first location (or the location 921). The processor 360 may identify the vehicle 920 having the license plate indicating the designated character string, based on the second video information obtained from the at least one external electronic device. The processor 360 may identify the vehicle 920 based on video information obtained from the second external electronic device 910-2. The processor 360 may identify the location of the vehicle 920 as a location 922, based on a second location where the second external electronic device 910-2 is disposed and a moment at which the video information including the vehicle 920 is obtained. The processor 360 may identify a moving path 930 of the vehicle 920 based on the location 921 and the location 922. The processor 360 may estimate a current location of the vehicle 920 by using a path prediction model, based on the moving path 930 of the vehicle 920. The processor 360 may estimate the current location of the vehicle 920 as a location 923.

As described above, the processor 360 of the server 102 may identify the location of the vehicle 920 having the license plate indicating the designated character string by using the plurality of external electronic devices disposed at different locations. Furthermore, the processor 360 may identify the moving path 930 of the vehicle 920 based on the location of the vehicle 920. The processor 360 may estimate the current location of the vehicle 920, based on the moving path 930 of the vehicle 920.

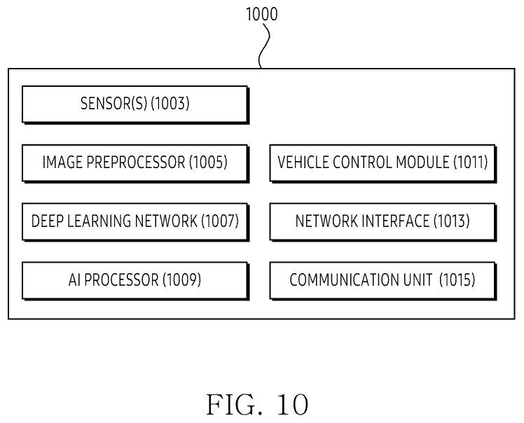

FIG. 10 is an example block diagram illustrating an autonomous driving system of a vehicle according to an embodiment.

The autonomous driving system 1000 of the vehicle according to FIG. 10 may be a deep learning network including sensors 1003, an image preprocessor 1005, a deep learning network 1007, an artificial intelligence (AI) processor 1009, a vehicle control module 1011, a network interface 1013, and a communication unit 1015. In various embodiments, each element may be connected via a variety of interfaces. For example, sensor data detected and output by the sensors 1003 may be fed to the image preprocessor 1005. The sensor data processed by the image preprocessor 1005 may be fed to the deep learning network 1007 run on the AI processor 1009. An output of the deep learning network 1007 run by the AI processor 1009 may be fed to the vehicle control module 1011. Intermediate results of the deep learning network 1007 run on the AI processor 1009 may be fed to the AI processor 1009. In various embodiments, the network interface 1013 communicates with an electronic device in the vehicle to transmit autonomous driving route information and/or autonomous driving control commands for autonomous driving of the vehicle to its internal block components. In an embodiment, the network interface 1013 may be used to transmit sensor data obtained through the sensor(s) 1003 to an external server. In some embodiments, the autonomous driving control system 1000 may include additional or fewer components as appropriate. For example, in some embodiments, the image preprocessor 1005 may be an optional component. As another example, a post-processing element (not shown) may be included in the autonomous driving control system 1000 to perform post-processing of the output of the deep learning network 1007 before the output is provided to the vehicle control module 1011.

In some embodiments, the sensors 1003 may include one or more sensors. In various embodiments, the sensors 1003 may be attached to various different positions of the vehicle. The sensors 1003 may be arranged to face one or more different directions. For example, the sensors 1003 may be attached to the front, sides, rear, and/or roof of the vehicle to face directions such as forward-facing, rear-facing, side-facing and the like. In some embodiments, the sensors 1003 may be image sensors such as e.g., high dynamic range cameras. In some embodiments, the sensors 1003 may include non-visual sensors. In some embodiments, the sensors 1003 may include a radar, a light detection and ranging (LiDAR), and/or ultrasonic sensors in addition to the image sensor. In some embodiments, the sensors 1003 are not mounted on the vehicle having the vehicle control module 1011. For example, the sensors 1003 may be incorporated as a part of a deep learning system for capturing sensor data and may be installed onto an environment or a roadway and/or mounted on surrounding vehicles.

In some embodiments, the image preprocessor 1005 may be used to preprocess sensor data of the sensors 1003. For example, the image preprocessor 1005 may be used to preprocess sensor data to split sensor data into one or more components, and/or to post-process the one or more components. In some embodiments, the image preprocessor 1005 may be any one of a graphics processing unit (GPU), a central processing unit (CPU), an image signal processor, or a specialized image processor. In various embodiments, the image preprocessor 1005 may be a tone-mapper processor for processing high dynamic range data. In some embodiments, the image preprocessor 1005 may be a component of the AI processor 1009.

In some embodiments, the deep learning network 1007 may be a deep learning network for implementing control commands for controlling the autonomous vehicle. For example, the deep learning network 1007 may be an artificial neural network such as a convolution neural network (CNN) trained using sensor data, and the output of the deep learning network 1007 is provided to the vehicle control module 1011.

In some embodiments, the AI processor 1009 may be a hardware processor for running the deep learning network 1007. In some embodiments, the AI processor 1009 may be a specialized AI processor adapted to perform inference on sensor data through a CNN. In some embodiments, the AI processor 1009 may be optimized for a bit depth of the sensor data. In some embodiments, the AI processor 1009 may be optimized for deep learning operations such as operations in neural networks including convolution, inner product, vector, and/or matrix operations. In some embodiments, the AI processor 1009 may be implemented through a plurality of graphics processing units (GPUs) capable of effectively performing parallel processing.

In various embodiments, the AI processor 1009 may be coupled, through an input/output interface, to a memory configured to provide an AI processor having instructions causing the AI processor to perform deep learning analysis on the sensor data received from the sensor(s) 1003 while the AI processor 1009 is executed, and determine a result of machine learning used to operate a vehicle at least partially autonomously. In some embodiments, the vehicle control module 1011 may be used to process commands for vehicle control outputted from the AI processor 1009, and to translate the output of the AI processor 1009 into commands for controlling modules of each vehicle in order to control various modules in the vehicle. In some embodiments, the vehicle control module 1011 is used to control an autonomous driving vehicle. In some embodiments, the vehicle control module 1011 may adjust the steering and/or speed of the vehicle. For example, the vehicle control module 1011 may be used to control driving of a vehicle such as e.g., deceleration, acceleration, steering, lane change, keeping lane or the like. In some embodiments, the vehicle control module 1011 may generate control signals for controlling vehicle lighting, such as e.g., brake lights, turns signals, and headlights. In some embodiments, the vehicle control module 1011 may be used to control vehicle audio-related systems such as e.g., a vehicle's sound system, vehicle's audio warnings, a vehicle's microphone system, and a vehicle's horn system.

In some embodiments, the vehicle control module 1011 may be used to control notification systems including alert systems for notifying passengers and/or a driver of driving events, such as e.g., approaching an intended destination or a potential collision. In some embodiments, the vehicle control module 1011 may be used to adjust sensors such as the sensors 1003 of the vehicle. For example, the vehicle control module 1011 may control to modify the orientation of the sensors 1003, change the output resolution and/or format type of the sensors 1003, increase or decrease a capture rate, adjust a dynamic range, and adjust the focus of the camera. In addition, the vehicle control module 1011 may control to turn on/off the operation of the sensors individually or collectively.

In some embodiments, the vehicle control module 1011 may be used to change the parameters of the image preprocessor 1005 by means of modifying a frequency range of filters, adjusting features and/or edge detection parameters for object detection, adjusting bit depth and channels, or the like. In various embodiments, the vehicle control module 1011 may be used to control autonomous driving of the vehicle and/or driver assistance features of the vehicle.

In some embodiments, the network interface 1013 may serve as an internal interface between the block components of the autonomous driving control system 1000 and the communication unit 1015. Specifically, the network interface 1013 may be a communication interface for receiving and/or transmitting data including voice data. In various embodiments, the network interface 1013 may be connected to external servers via the communication unit 1015 to connect voice calls, receive and/or send text messages, transmit sensor data, update software of the vehicle to the autonomous driving system, or update software of the autonomous driving system of the vehicle.

In various embodiments, the communication unit 1015 may include various wireless interfaces of a cellular or WiFi type. For example, the network interface 1013 may be used to receive updates of the operation parameters and/or instructions for the sensors 1003, the image preprocessor 1005, the deep learning network 1007, the AI processor 1009, and the vehicle control module 1011 from an external server connected via the communication unit 1015. For example, a machine learning model of the deep learning network 1007 may be updated using the communication unit 1015. According to another embodiment, the communication unit 1015 may be used to update the operating parameters of the image preprocessor 1005, such as image processing parameters, and/or the firmware of the sensors 1003.

In another embodiment, the communication unit 1015 may be used to activate communication for emergency services and emergency contacts in an event of a traffic accident or a near-accident. For example, in a vehicle crash event, the communication unit 1015 may be used to call emergency services for help, and may be used to externally notify the crash details and the location of the vehicle to the designated emergency services. In various embodiments, the communication unit 1015 may update or obtain an expected arrival time and/or a location of destination.

According to an embodiment, the autonomous driving system 1000 illustrated in FIG. 10 may be configured as an electronic device of a vehicle. According to an embodiment, when an autonomous driving release event occurs from the user while performing the autonomous driving of the vehicle, the AI processor 1009 of the autonomous driving system 1000 may make a control to input information related to the autonomous driving release event to the training set data of the deep learning network, thereby controlling to train the autonomous driving software of the vehicle.

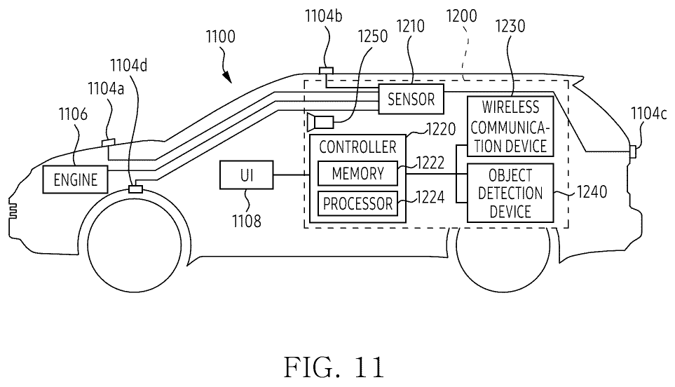

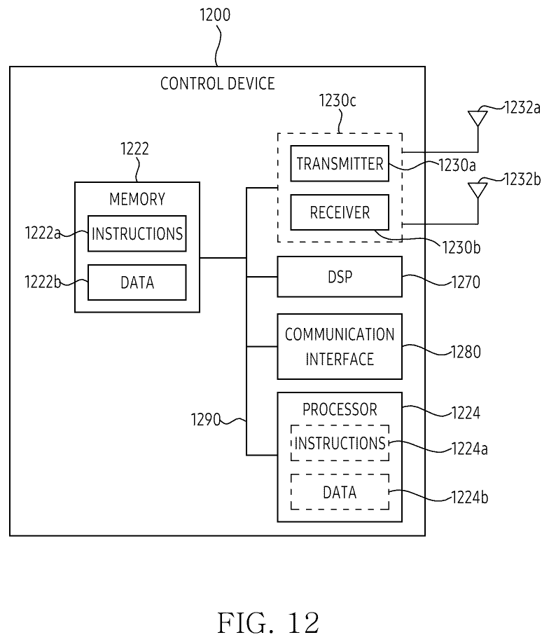

FIGS. 11 and 12 are example block diagrams illustrating an autonomous driving mobile body according to an embodiment. Referring to FIG. 11, the autonomous driving mobile body 1100 according to the present embodiment may include a control device 1200, sensing modules (1104a, 1104b, 1104c, 1104d), an engine 1106, and a user interface 1108.

The autonomous driving mobile body 1100 may have an autonomous driving mode or a manual mode. For example, according to a user input received through the user interface 1108, the manual mode may be switched to the autonomous driving mode, or the autonomous driving mode may be switched to the manual mode.

When the mobile body 1100 is operated in the autonomous driving mode, the autonomous driving mobile body 1100 may be operated under the control of the control device 1200.

In this embodiment, the control device 1200 may include a controller 1220 including a memory 1222 and a processor 1224, a sensor 1210, a communication device 1230, and an object detection device 1240.

Here, the object detection device 1240 may perform all or some of functions of the distance measuring device (e.g., the electronic device 101).

In other words, in the present embodiment, the object detection device 1240 is a device for detecting an object located outside the mobile body 1100, and the object detection device 1240 may be configured to detect an object located outside the mobile body 1100 and generate object information according to a result of the detection.

The object information may include information on the presence or absence of an object, location information of the object, distance information between the mobile body and the object, and relative speed information between the mobile body and the object.

The object may include various objects located outside the mobile body 1100, such as a traffic lane, another vehicle, a pedestrian, a traffic signal, light, a roadway, a structure, a speed bump, terrain, an animal, and the like. Here, the traffic signal may be of a concept including a traffic light, a traffic sign, a pattern or text drawn on a road surface. The light may be light generated from a lamp provided in another vehicle, light emitted from a streetlamp, or sunlight.

Further, the structure may indicate an object located around the roadway and fixed to the ground. For example, the structure may include, for example, a streetlamp, a street tree, a building, a telephone pole, a traffic light, a bridge, and the like. The terrain may include mountains, hills, and the like.

Such an object detection device 1240 may include a camera module. The controller 1220 may extract object information from an external image captured by the camera module and allow the controller 1220 to process the information.

Further, the object detection device 1240 may further include imaging devices for recognizing an external environment. A RADAR, a GPS device, a driving distance measuring device (odometer), other computer vision devices, ultrasonic sensors, and infrared sensors may be used in addition to a LIDAR, and these devices may be operated optionally or simultaneously as needed to enable more precise detection.

Meanwhile, the distance measuring device according to an embodiment of the disclosure may calculate the distance between the autonomous driving mobile body 1100 and the object, and control the operation of the mobile body based on the distance calculated in association with the control device 1200 of the autonomous driving mobile body 1100.

For example, when there is a possibility of collision depending upon the distance between the autonomous driving mobile body 1100 and the object, the autonomous driving mobile body 1100 may control the brake to slow down or stop. As another example, when the object is a moving object, the autonomous driving mobile body 1100 may control the driving speed of the autonomous driving mobile body 1100 to maintain a predetermined distance or more from the object.

The distance measuring device according to an embodiment of the disclosure may be configured as one module within the control device 1200 of the autonomous driving mobile body 1100. In other words, the memory 1222 and the processor 1224 of the control device 1200 may be configured to implement in software a collision avoidance method according to the present disclosure.

Further, the sensor 1210 may be connected to the sensing modules (1104a, 1104b, 1104c, 1104d) to obtain various sensing information about the environment inside and outside the mobile body. Here, the sensor 1210 may include, for example, a posture sensor (e.g., a yaw sensor, a roll sensor, a pitch sensor), a collision sensor, a wheel sensor, a speed sensor, an inclination sensor, a weight detection sensor, a heading sensor, a gyro sensor, a position module, a mobile body forward/backward sensor, a battery sensor, a fuel sensor, a tire sensor, a steering sensor for steering wheel rotation, a mobile body internal temperature sensor, a mobile body internal humidity sensor, an ultrasonic sensor, an illuminance sensor, an accelerator pedal position sensor, a brake pedal position sensor, and the like.

As such, the sensor 1210 may obtain various sensing signals, such as e.g., mobile body posture information, mobile body collision information, mobile body direction information, mobile body position information (GPS information), mobile body angle information, mobile body speed information, mobile body acceleration information, mobile body inclination information, mobile body forward/backward driving information, battery information, fuel information, tire information, mobile body lamp information, mobile body internal temperature information, mobile body internal humidity information, steering wheel rotation angle, mobile body external illuminance, pressure applied to an accelerator pedal, pressure applied to a brake pedal, and so on.

Further, the sensor 1210 may further include an accelerator pedal sensor, a pressure sensor, an engine speed sensor, an air flow sensor (AFS), an intake air temperature sensor (ATS), a water temperature sensor (WTS), a throttle position sensor (TPS), a top dead center (TDC) sensor, a crank angle sensor (CAS), and the like.

As such, the sensor 1210 may generate mobile body state information based on various detected data.

A wireless communication device 1230 may be configured to implement wireless communication between the autonomous driving mobile bodies 1100. For example, the autonomous driving mobile body 1100 can communicate with a mobile phone of the user or another wireless communication device 1230, another mobile body, a central apparatus (traffic control device), a server, or the like. The wireless communication device 1230 may transmit and receive wireless signals according to a wireless access protocol. The wireless communication protocol may be, for example, of Wi-Fi, Bluetooth, Long-Term Evolution (LTE), Code Division Multiple Access (CDMA), Wideband Code Division Multiple Access (WCDMA), and Global Systems for Mobile Communications (GSM), and the communication protocol is not limited thereto.

Further, according to the present embodiment, the autonomous driving mobile body 1100 may implement wireless communication between mobile bodies via the wireless communication device 1230. In other words, the wireless communication device 1230 may communicate with another mobile body and other mobile bodies over the road through vehicle-to-vehicle (V2V) communication. The autonomous driving mobile body 1100 may transmit and receive information, such as driving warnings and traffic information, via the vehicle-to-vehicle communication, and may request information or receive such a request from another vehicle. For example, the wireless communication device 1230 may perform the V2V communication with a dedicated short-range communication (DSRC) apparatus or a cellular-V2V (C-V2V) apparatus. In addition to vehicle-to-vehicle communication, vehicle-to-everything (V2X) communication between a vehicle and another object (e.g., an electronic device carried by a pedestrian) may also be implemented using the wireless communication device 1230.

Further, the wireless communication device 1230 may obtain, as information for autonomous driving of the autonomous driving mobile body 1100, information generated by various mobility devices including infrastructure (traffic lights, CCTVs, RSUs, eNode B, etc.), other autonomous driving/non-autonomous driving vehicles or the like that are located on a roadway over a non-terrestrial network other than a terrestrial network.

For example, the wireless communication device 1230 may perform wireless communication with a low earth orbit (LEO) satellite system, a medium earth orbit (MEO) satellite system, a geostationary orbit (GEO) satellite system, a high altitude platform (HAP) system, and so on, all these systems constituting a non-terrestrial network, via a dedicated non-terrestrial network antenna mounted on the autonomous driving mobile body 1100.

For example, the wireless communication device 1230 may perform wireless communication with various platforms that configure a Non-Terrestrial Network (NTN) according to the wireless access specification complying with the 5G NR NTN (5^{th} Generation New Radio Non-Terrestrial Network) standard currently being discussed in 3GPP and others, but the disclosure is not limited thereto.

In this embodiment, the controller 1220 may control the wireless communication device 1230 to select a platform capable of appropriately performing the NTN communication in consideration of various information, such as the location of the autonomous driving mobile body 1100, the current time, available power, and the like and to perform wireless communication with the selected platform.

In this embodiment, the controller 1220, which is a unit for controlling the overall operation of each unit in the mobile body 1100, may be configured at the time of manufacture by a manufacturer of the mobile body or may be additionally adapted to perform an autonomous driving function after its manufacture. Alternatively, a configuration may be included for enabling the controller to continue ongoing additional functions through upgrades to the controller 1220 configured at the time of its manufacturing. Such a controller 1220 may be referred to as an electronic control unit (ECU).

The controller 1220 may be configured to collect various data from the sensor 1210 connected thereto, the object detection device 1240, the communication device 1230, and the like, and may transmit a control signal based on the collected data to the sensor 1210, the engine 1106, the user interface 1108, the wireless communication device 1230, and the object detection device 1240 that are included as other components in the mobile body. Further, although not shown herein, the control signal may be also transmitted to an accelerator, a braking system, a steering device, or a navigation device related to driving of the mobile body.

According to the present embodiment, the controller 1220 may control the engine 1106, and for example, the controller 1220 may control the engine 1106 to detect a speed limit of the roadway on which the autonomous driving mobile body 1100 is driving and to prevent its driving speed from exceeding the speed limit, or may control the engine 1106 to accelerate the driving speed of the autonomous driving mobile body 1100 within a range not exceeding the speed limit.

Further, in case where the autonomous driving mobile body 1100 is approaching the lane or departing from the lane during the driving of the autonomous driving mobile body 1100, the controller 1220 may determine whether such approaching the lane or departing from the lane is due to a normal driving condition or other driving conditions, and control the engine 1106 to control the driving of the vehicle based on the result of determination. More specifically, the autonomous driving mobile body 1100 may detect lanes formed on both sides of the lane in which the vehicle is driving. In such a case, the controller 1220 may determine whether the autonomous driving mobile body 1100 is approaching the lane or departing from the lane, and if it is determined that the autonomous driving mobile body 1100 is approaching the lane or departing from the lane, then the controller 1220 may determine whether such driving is in accordance with the correct driving condition or other driving conditions. Here, an example of the normal driving condition may be a situation where it is necessary to change the lane of the mobile body. Further, an example of other driving conditions may be a situation where it is not necessary to change the lane of the mobile body. When it is determined that the autonomous driving mobile body 1100 is approaching or leaving the lane in a situation where it is not necessary for the mobile body to change the lane, the controller 1220 may control the driving of the autonomous driving mobile body 1100 such that the autonomous driving mobile body 1100 does not leave the lane and continue to drive normally in that lane.

When another mobile body or any obstruction exists in front of the mobile body, the controller may control the engine 1106 or the braking system to decelerate the mobile body, and control the trajectory, the driving route, and the steering angle of the mobile body in addition to the driving speed. Alternatively, the controller 1220 may control the driving of the mobile body by generating necessary control signals based on information collected from the external environment, such as, e.g., the driving lane of the mobile body, the driving signals, and the like.

In addition to generating its own control signals, the controller 1220 may communicate with a neighboring mobile body or a central server and transmit commands for controlling peripheral devices through the information received therefrom, thereby controlling the driving of the mobile body.

Further, when the position of the camera module 1250 changes or the angle of view changes, it may be difficult to accurately recognize the mobile body or the lane in accordance with the present embodiment, and thus the controller 1220 may generate a control signal for controlling to perform calibration of the camera module 1250 in order to prevent such a phenomenon. Accordingly, in this embodiment, the controller 1220 may generate a calibration control signal to the camera module 1250 to continuously maintain the normal mounting position, orientation, angle of view, etc. of the camera module 1250, even if the mounting position of the camera module 1250 is changed due to vibrations or impacts generated according to the movement of the autonomous driving mobile body 1100. The controller 1220 may generate a control signal to perform calibration of the camera module 1250, in case where the pre-stored initial information of mounting position, orientation, and angle of view of the camera module 1250 varies by more than a threshold value from the initial mounting position, direction, and angle of view information of the camera module 1250 measured during the driving of the autonomous driving mobile body 1100.

In this embodiment, the controller 1220 may include a memory 1222 and a processor 1224. The processor 1224 may execute software stored in the memory 1222 according to a control signal of the controller 1220. More specifically, the controller 1220 may store in the memory 1222 data and instructions for performing the lane detection method in accordance with the present disclosure, and the instructions may be executed by the processor 1224 to implement the one or more methods disclosed herein.

In such a circumstance, the memory 1222 may be included in a non-volatile recording medium executable by the processor 1224. The memory 1222 may store software and data through an appropriate internal and external device. The memory 1222 may be comprised of a random access memory (RAM), a read only memory (ROM), a hard disk, and another memory 1222 connected to a dongle.

The memory 1222 may store at least an operating system (OS), a user application, and executable instructions. The memory 1222 may also store application data, array data structures and the like.

The processor 1224 may be a microprocessor or an appropriate electronic processor, such as a controller, a microcontroller, or a state machine.

The processor 1224 may be implemented as a combination of computing devices, and the computing device may include a digital signal processor, a microprocessor, or an appropriate combination thereof.

Meanwhile, the autonomous driving mobile body 1100 may further include a user interface 1108 for a user input to the control device 1200 described above. The user interface 1108 may allow the user to input information with appropriate interaction. For example, it may be implemented as a touch screen, a keypad, a control button, etc. The user interface 1108 may transmit an input or command to the controller 1220, and the controller 1220 may perform a control operation of the mobile body in response to the input or command.

Further, the user interface 1108 may allow a device outside the autonomous driving mobile body 1100 to communicate with the autonomous driving mobile body 1100 through the wireless communication device 1230. For example, the user interface 1108 may be in association with a mobile phone, a tablet, or other computing devices.

Furthermore, this embodiment describes that the autonomous driving mobile body 1100 includes the engine 1106, but it may be also possible to include another type of propulsion system. For example, the mobile body may be operated with electrical energy or may be operable by means of hydrogen energy or a hybrid system in combination thereof. Thus, the controller 1220 may include a propulsion mechanism according to the propulsion system of the autonomous driving mobile body 1100, and may provide control signals to components of each of the propulsion mechanism accordingly.

Hereinafter, a detailed configuration of the control device 1200 according to the present embodiment will be described in more detail with reference to FIG. 12.

The control device 1200 includes a processor 1224. The processor 1224 may be a general-purpose single-chip or multi-chip microprocessor, a dedicated microprocessor, a microcontroller, a programmable gate array, or the like. The processor may be referred to as a central processing unit (CPU). In this embodiment, the processor 1224 may be implemented with a combination of a plurality of processors.

The control device 1200 also includes a memory 1222. The memory 1222 may be any electronic component capable of storing electronic information. The memory 1222 may also include a combination of memories 1222 in addition to a single memory.

Data and instructions 1222a for performing a distance measuring method of the distance measuring device according to the present disclosure may be stored in the memory 1222. When the processor 1224 executes the instructions 1222a, all or some of the instructions 1222a and the data 1222b required for executing the instructions may be loaded onto the processor 1224 (e.g., 1224a or 1224b).

The control device 1200 may include a transmitter 1230a, a receiver 1230b, or a transceiver 1230c for allowing transmission and reception of signals. The one or more antennas (1232a, 1232b) may be electrically connected to the transmitter 1230a, the receiver 1230b, or each transceiver 1230c, or may further include antennas.

The control device 1200 may include a digital signal processor (DSP) 1270. The DSP 1270 may allow the mobile body to quickly process digital signals.

The control device 1200 may include a communication interface 1280. The communication interface 1280 may include one or more ports and/or communication modules for connecting other devices to the control device 1200. The communication interface 1280 may allow the user and the control device 1200 to interact with each other.

Various components of the control device 1200 may be connected together by one or more buses 1290, and the buses 1290 may include a power bus, a control signal bus, a state signal bus, a data bus, and the like. Under the control of the processor 1224, the components may transmit information to each other via the bus 1290 and perform a desired function.

Meanwhile, in various embodiments, the control device 1200 may be related to a gateway for communication with a security cloud.

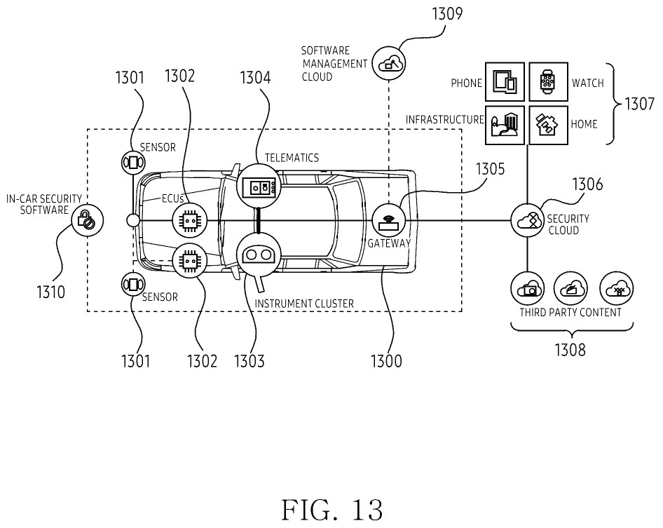

FIG. 13 illustrates an example of a gateway related to a user device according to various embodiments.

referring to FIG. 13, the control device 1200 may be related to a gateway 1305 for providing information obtained from at least one of components 1301 to 1304 of a vehicle 1300 to a security cloud 1306. For example, the gateway 1305 may be included in the control device 1200. As another example, the gateway 1305 may be configured as a separate device in the vehicle 1300 distinguished from the control device 1200. The gateway 1305 connects a software management cloud 1309 and a security cloud 1306, having different networks, with the network within the vehicle 1300 secured by in-car security software 1310, so that they can communicate with each other.

For example, a component 1301 may be a sensor. For example, the sensor may be used to obtain information about at least one of a state of the vehicle 1300 or a state around the vehicle 1300. For example, the component 1301 may include a sensor 1210.

For example, a component 1302 may be an electronic control unit (ECU). For example, the ECU may be used for engine control, transmission control, airbag control, and tire air-pressure management.

For example, a component 1303 may be an instrument cluster. For example, the instrument cluster may refer to a panel positioned in front of a driver's seat in a dashboard. For example, the instrument cluster may be configured to display information necessary for driving to the driver (or a passenger). For example, the instrument cluster may be used to display at least one of visual elements for indicating revolutions per minute (RPM) or rotations per minute of an engine, visual elements for indicating the speed of the vehicle 1300, visual elements for indicating a remaining fuel amount, visual elements for indicating a state of a transmission gear, or visual elements for indicating information obtained through the element 1301.

For example, a component 1004 may be a telematics device. For example, the telematics device may refer to an apparatus that combines wireless communication technology and global positioning system (GPS) technology to provide various mobile communication services, such as location information, safe driving or the like in the vehicle 1300. For example, the telematics device may be used to connect the vehicle 1300 with the driver, a cloud (e.g., the security cloud 1306), and/or a surrounding environment. For example, the telematics device may be configured to support a high bandwidth and a low latency, for a 5G NR standard technology (e.g., a V2X technology of 5G NR or a non-terrestrial network (NTN) technology of 5G NR). For example, the telematics device may be configured to support an autonomous driving of the vehicle 1300.

For example, the gateway 1305 may be used to connect the in-vehicle network within the vehicle 1300 with the software management cloud 1309 and the security cloud 1306, which are out-of-vehicle networks. For example, the software management cloud 1309 may be used to update or manage at least one software required for driving and managing of the vehicle 1300. For example, the software management cloud 1309 may be associated with the in-car security software 1310 installed in the vehicle. For example, the in-car security software 1310 may be used to provide a security function in the vehicle 1300. For example, the in-car security software 1310 may encrypt data transmitted and received via the in-vehicle network, using an encryption key obtained from an external authorized server for encryption of the in-vehicle network. In various embodiments, the encryption key used by the in-car security software 1310 may be generated based on the vehicle identification information (vehicle license plate, vehicle identification number (VIN)) or information uniquely assigned to each user (e.g., user identification information).

In various embodiments, the gateway 1305 may transmit data encrypted by the in-car security software 1310 based on the encryption key, to the software management cloud 1309 and/or the security cloud 1306. The software management cloud 1309 and/or the security cloud 1306 may use a decryption key capable of decrypting the data encrypted by the encryption key of the in-car security software 1310 to identify from which vehicle or user the data has been received. For example, since the decryption key is a unique key corresponding to the encryption key, the software management cloud 1309 and/or the security cloud 1306 may identify a sending entity (e.g., the vehicle or the user) of the data based on the data decrypted using the decryption key.

For example, the gateway 1305 may be configured to support the in-car security software 1310 and may be related to the control device 1200. For example, the gateway 1305 may be related to the control device 1200 to support a connection between the client device 1307 connected to the security cloud 1306 and the control device 1200. As another example, the gateway 1305 may be related to the control device 1200 to support a connection between a third party cloud 1308 connected to the security cloud 1306 and the control device 1200. However, the disclosure is not limited thereto.

In various embodiments, the gateway 1305 may be used to connect the vehicle 1300 to the software management cloud 1309 for managing the operating software of the vehicle 1300. For example, the software management cloud 1309 may monitor whether update of the operating software of the vehicle 1300 is required, and may provide data for updating the operating software of the vehicle 1300 through the gateway 1305, based on monitoring that the update of the operating software of the vehicle 1300 is required. As another example, the software management cloud 1309 may receive a user request to update the operating software of the vehicle 1300 from the vehicle 1300 via the gateway 1305 and provide data for updating the operating software of the vehicle 1300 based on the received user request. However, the disclosure is not limited thereto.

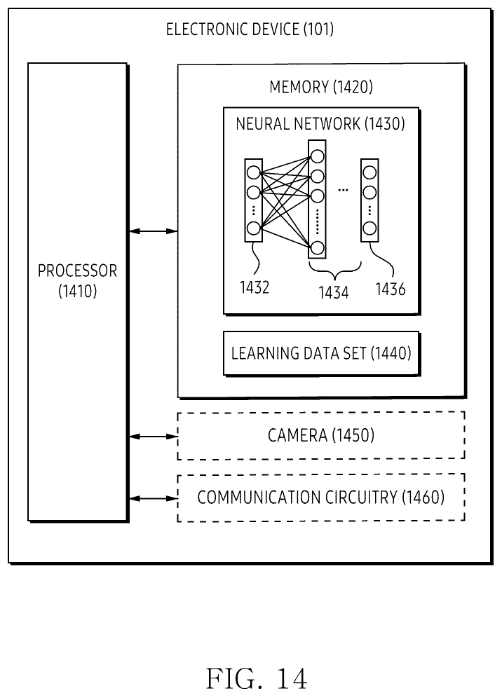

FIG. 14 is a block diagram of an electronic device 101 according to an embodiment. The electronic device 101 of FIG. 14 may include the electronic device (or server 102) of FIGS. 1 to 13.

Referring to FIG. 14, a processor 1410 of the electronic device 101 may perform computations related to a neural network 1430 stored in a memory 1420. The processor 1410 may include at least one of a central processing unit (CPU), a graphic processing unit (GPU), or a neural processing unit (NPU). The NPU may be implemented as a chip separated from the CPU, or may be integrated into a chip such as the CPU in the form of a system on chip (SoC). The NPU integrated in the CPU may be referred to as a neural core and/or an artificial intelligence (AI) accelerator.

Referring to FIG. 14, the processor 1410 may identify the neural network 1430 stored in the memory 1420. The neural network 1430 may include a combination of an input layer 1432, one or more hidden layers 1434 (or intermediate layers), and an output layer 1436. The above-described layers (e.g., the input layer 1432, the one or more hidden layers 1434, and the output layer 1436) may include a plurality of nodes. The number of hidden layers 1434 may vary depending on embodiments, and the neural network 1430 including a plurality of hidden layers 1434 may be referred to as a deep neural network. Operation of training the deep neural network may be referred to as deep learning.

In an embodiment, when the neural network 1430 has a structure of a feed forward neural network, a first node included in a particular layer may be connected to all of second nodes included in another prior to that particular layer. In the memory 1420, the parameters stored for the neural network 1430 may include weights assigned to connections between the second nodes and the first node. In the neural network 1430 having such a structure of feedforward neural network, a value of the first node may correspond to a weighted sum of values assigned to the second nodes, based on weights assigned to connections connecting the second nodes and the first node.

In an embodiment, when the neural network 1430 has a structure of a convolutional neural network, a first node included in a particular layer may correspond to a weighted sum of some of second nodes included in another layer prior to that particular layer. Some of the second nodes corresponding to the first node may be identified by a filter corresponding to the particular layer. In the memory 1420, the parameters stored for the neural network 1430 may include weights indicating the filter. The filter may include, among the second nodes, one or more nodes to be used to calculate a weighted sum of the first nodes, and weights corresponding to the one or more nodes, respectively.

According to an embodiment, the processor 1410 of the electronic device 101 may perform training on the neural network 1430, using the training data set 1440 stored in the memory 1420. Based on the training data set 1440, the processor 1410 may adjust one or more parameters stored in the memory 1420 for the neural network 1430.

According to an embodiment, the processor 1410 of the electronic device 101 may perform object detection, object recognition, and/or object classification, using the neural network 1430 trained based on the training data set 1440. The processor 1410 may input an image (or video) obtained through the camera 1450 to the input layer 1432 of the neural network 1430. Based on the input layer 1432 to which the image is input, the processor 1410 may sequentially obtain values of nodes of layers included in the neural network 1430 to obtain a set (e.g., output data) of values of nodes of the output layer 1436. The output data may be used based on a result of inferring information included in the image using the neural network 1430. Embodiments of the disclosure are not limited thereto, and the processor 1410 may input, to the neural network 1430, an image (or video) obtained from an external electronic device connected to the electronic device 101 through the communication circuit 1460.

In an embodiment, the neural network 1430 trained to process an image may be used to identify an area corresponding to a subject in the image (e.g., object detection) and/or identify a class of the subject represented in the image (e.g., object recognition and/or object classification). For example, the electronic device 101 may segment an area corresponding to the subject in the image, based on a rectangular shape such as e.g., a bounding box, using the neural network 1430. For example, the electronic device 101 may identify at least one class that matches the subject from among a plurality of specified classes, using the neural network 1430.

According to an embodiment, an electronic device may comprise at least one camera, communication circuitry, memory, and at least one processor operably connected with the at least one camera, the communication circuitry, and the memory, and the processor may be configured to obtain video information through the at least one camera, identify a plurality of images including a designated vehicle based on the video information, identify a designated area corresponding to a license plate of the designated vehicle within the plurality of images, based on the plurality of images, transmit image information on the designated area to a server connected to the electronic device, based on transmitting the image information on the designated area to the server, receive text information on the designated area from the server, and based on the text information, provide a character string represented on the license plate.

According to an embodiment, the at least one processor may be further configured to, based on data obtained through the at least one camera, receive a user input for setting a designated time, and based on the user input, obtain the video information on the designated time interval.

According to an embodiment, the at least one processor may be further configured to, based on tracking the designated vehicle included in the video information through an object detection (OD) model, identify a plurality of frames including the designated vehicle. The plurality of images may be obtained based on the plurality of frames.

According to an embodiment, the at least one processor may be further configured to, based on the designated area corresponding to the license plate, perform an algorithm for identifying the character string represented on the license plate, and based on a failure of identification of the character string according to the algorithm, transmit the image information on the designated area to the server.

According to an embodiment, the image information on the designated area may be set as input data of a recognition model, which is included in the server and indicated by a plurality of parameters. The text information on the designated area may be obtained based on output data of the recognition model.

According to an embodiment, the video information may include at least one of location information of the electronic device, speed information of the electronic device, acceleration information of the electronic device, or path information of the electronic device.

According to an embodiment, the text information may include candidate character strings for the character string represented on the license plate and reliability information for the candidate strings. The at least one processor may be further configured to, based on the reliability information, provide one of the candidate character strings as the character string represented on the license plate.

According to an embodiment, a method performed by an electronic device may comprise obtaining video information through at least one camera of the electronic device, identifying a plurality of images including a designated vehicle based on the video information, identifying a designated area corresponding to a license plate of the designated vehicle within the plurality of images, based on the plurality of images, transmitting image information on the designated area to a server connected to the electronic device, based on transmitting the image information on the designated area to the server, receiving text information on the designated area from the server, and based on the text information, providing a character string represented on the license plate.

According to an embodiment, the method may further comprise, based on data obtained through the at least one camera, receiving a user input for setting a designated time, and based on the user input, obtaining the video information on the designated time interval.

According to an embodiment, the method may further comprise, based on tracking the designated vehicle included in the video information through an object detection (OD) model, identifying a plurality of frames including the designated vehicle. The plurality of images may be obtained based on the plurality of frames.

According to an embodiment, the method may further comprise, based on the designated area corresponding to the license plate, performing an algorithm for identifying the character string represented on the license plate, and based on a failure of identification of the character string according to the algorithm, transmitting the image information on the designated area to the server.

According to an embodiment, the image information on the designated area may be set as input data of a recognition model, which is included in the server and indicated by a plurality of parameters. The text information on the designated area may be obtained based on output data of the recognition model.

According to an embodiment, the video information may include at least one of location information of the electronic device, speed information of the electronic device, acceleration information of the electronic device, or path information of the electronic device.

According to an embodiment, the text information may include candidate character strings for the character string represented on the license plate and reliability information for the candidate strings. The method may further comprise, based on the reliability information, providing one of the candidate character strings as the character string represented on the license plate.

A non-transitory computer readable storage medium may store one or more programs. The one or more programs may comprise instructions which, when executed by at least one processor of an electronic device including at least one camera, communication circuitry, and memory, cause the electronic device to obtain video information through the at least one camera, identify a plurality of images including a designated vehicle based on the video information, identify a designated area corresponding to a license plate of the designated vehicle within the plurality of images, based on the plurality of images, transmit image information on the designated area to a server connected to the electronic device, based on transmitting the image information on the designated area to the server, receive text information on the designated area from the server, and based on the text information, provide a character string represented on the license plate.

According to an embodiment, the one or more programs may comprise instructions which, when executed by the at least one processor, cause the electronic device to, based on data obtained through the at least one camera, receive a user input for setting a designated time, and based on the user input, obtain the video information on the designated time interval.

According to an embodiment, the one or more programs may comprise instructions which, when executed by the at least one processor, cause the electronic device to, based on tracking the designated vehicle included in the video information through an object detection (OD) model, identify a plurality of frames including the designated vehicle. The plurality of images may be obtained based on the plurality of frames.

According to an embodiment, the one or more programs may comprise instructions which, when executed by the at least one processor, cause the electronic device to, based on the designated area corresponding to the license plate, perform an algorithm for identifying the character string represented on the license plate, and based on a failure of identification of the character string according to the algorithm, transmit the image information on the designated area to the server.

According to an embodiment, the image information on the designated area may be set as input data of a recognition model, which is included in the server and indicated by a plurality of parameters. The text information on the designated area may be obtained based on output data of the recognition model.

According to an embodiment, an electronic device may comprise communication circuitry, memory, and at least one processor operably connected with the communication circuitry and the memory. The processor may be configured to, based on first video information obtained from a first external electronic device disposed at a first location, identify a designated vehicle having a license plate indicating a designated character string, based on the first video information, identify speed information of the designated vehicle, based on the first location, identify at least one external electronic device within a radius identified based on the speed information of the designated vehicle, based on second video information obtained from the at least one external electronic device, identify the designated vehicle having the license plate indicating the designated character string, based on identifying the designated vehicle, identify a second external electronic device obtaining video information including the designated vehicle from among the at least one external electronic device, and based on a second location on which the second external electronic device is disposed and a moment at which the video information including the designated vehicle is obtained, identify a location of the designated vehicle.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. The singular form of a noun corresponding to an item may include one or more of said items, unless the context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

In the embodiments of the present disclosure, the elements included in the present disclosure are expressed in a singular or plural form. However, the singular or plural expression is appropriately selected according to a proposed situation for the convenience of explanation, the present disclosure is not limited to a single element or a plurality of elements, the elements expressed in the plural form may be configured as a single element, and the elements expressed in the singular form may be configured as a plurality of elements.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

While embodiments of the present disclosure have been described, various changes may be made without departing the scope of the present disclosure.

What is claimed is:

1. An electronic device comprising:
at least one camera;
communication circuitry;
memory; and
at least one processor operably connected with the at least one camera, the communication circuitry, and the memory, and
wherein the processor is configured to:
obtain video information through the at least one camera;
identify a plurality of images including a designated vehicle based on the video information;
identify a designated area corresponding to a license plate of the designated vehicle within the plurality of images;
based on the plurality of images, transmit image information on the designated area to a server connected to the electronic device;
based on transmitting the image information on the designated area to the server, receive text information on the designated area from the server; and
based on the text information, provide a character string represented on the license plate.

2. The electronic device of claim 1,
wherein the at least one processor is further configured to:
based on data obtained through the at least one camera, receive a user input for setting a designated time interval; and
based on the user input, obtain the video information on the designated time interval.

3. The electronic device of claim 1,
wherein the at least one processor is further configured to:
based on tracking the designated vehicle included in the video information through an object detection (OD) model, identify a plurality of frames including the designated vehicle, and
wherein the plurality of images is obtained based on the plurality of frames.

4. The electronic device of claim 1,
wherein the at least one processor is further configured to:
based on the designated area corresponding to the license plate, perform an algorithm for identifying the character string represented on the license plate; and
based on a failure of identification of the character string according to the algorithm, transmit the image information on the designated area to the server.

5. The electronic device of claim 1,
wherein the image information on the designated area is set as input data of a recognition model, which is included in the server and indicated by a plurality of parameters, and
wherein the text information on the designated area is obtained based on output data of the recognition model.

6. The electronic device of claim 1,
wherein the video information includes at least one of location information of the electronic device, speed information of the electronic device, acceleration information of the electronic device, or path information of the electronic device.

7. The electronic device of claim 1,
wherein the text information includes candidate character strings for the character string represented on the license plate and reliability information for the candidate strings, and
wherein the at least one processor is further configured to:
based on the reliability information, provide one of the candidate character strings as the character string represented on the license plate.

8. A method performed by an electronic device comprising:
obtaining video information through at least one camera of the electronic device;
identifying a plurality of images including a designated vehicle based on the video information;
identifying a designated area corresponding to a license plate of the designated vehicle within the plurality of images;
based on the plurality of images, transmitting image information on the designated area to a server connected to the electronic device;
based on transmitting the image information on the designated area to the server, receiving text information on the designated area from the server; and
based on the text information, providing a character string represented on the license plate.

9. The method of claim 8, further comprising:
based on data obtained through the at least one camera, receiving a user input for setting a designated time interval; and
based on the user input, obtaining the video information on the designated time interval.

10. The method of claim 8, further comprising:
based on tracking the designated vehicle included in the video information through an object detection (OD) model, identifying a plurality of frames including the designated vehicle, and
wherein the plurality of images is obtained based on the plurality of frames.

11. The method of claim 8, further comprising:
based on the designated area corresponding to the license plate, performing an algorithm for identifying the character string represented on the license plate; and
based on a failure of identification of the character string according to the algorithm, transmitting the image information on the designated area to the server.

12. The method of claim 8,
wherein the image information on the designated area is set as input data of a recognition model, which is included in the server and indicated by a plurality of parameters, and
wherein the text information on the designated area is obtained based on output data of the recognition model.

13. The method of claim 8,
wherein the video information includes at least one of location information of the electronic device, speed information of the electronic device, acceleration information of the electronic device, or path information of the electronic device.

14. The method of claim 8,
wherein the text information includes candidate character strings for the character string represented on the license plate and reliability information for the candidate strings, and
wherein the method further comprises:
based on the reliability information, providing one of the candidate character strings as the character string represented on the license plate.

15. A non-transitory computer readable storage medium storing one or more programs,
wherein the one or more programs comprises instructions which, when executed by at least one processor of an electronic device including at least one camera, communication circuitry, and memory, cause the electronic device to:
obtain video information through the at least one camera;
identify a plurality of images including a designated vehicle based on the video information;
identify a designated area corresponding to a license plate of the designated vehicle within the plurality of images;
based on the plurality of images, transmit image information on the designated area to a server connected to the electronic device;
based on transmitting the image information on the designated area to the server, receive text information on the designated area from the server; and
based on the text information, provide a character string represented on the license plate.

16. The non-transitory computer readable storage medium of claim 15,
wherein the one or more programs comprises instructions which, when executed by the at least one processor, cause the electronic device to:
based on data obtained through the at least one camera, receive a user input for setting a designated time interval; and
based on the user input, obtain the video information on the designated time interval.

17. The non-transitory computer readable storage medium of claim 15,
wherein the one or more programs comprises instructions which, when executed by the at least one processor, cause the electronic device to:
based on tracking the designated vehicle included in the video information through an object detection (OD) model, identify a plurality of frames including the designated vehicle, and
wherein the plurality of images is obtained based on the plurality of frames.

18. The non-transitory computer readable storage medium of claim 15,
wherein the one or more programs comprises instructions which, when executed by the at least one processor, cause the electronic device to:
based on the designated area corresponding to the license plate, perform an algorithm for identifying the character string represented on the license plate; and
based on a failure of identification of the character string according to the algorithm, transmit the image information on the designated area to the server.

19. The non-transitory computer readable storage medium of claim 15,
wherein the image information on the designated area is set as input data of a recognition model, which is included in the server and indicated by a plurality of parameters, and
wherein the text information on the designated area is obtained based on output data of the recognition model.

20. An electronic device comprising:
communication circuitry;
memory; and
at least one processor operably connected with the communication circuitry and the memory, and
wherein the processor is configured to:
based on first video information obtained from a first external electronic device disposed at a first location, identify a designated vehicle having a license plate indicating a designated character string;
based on the first video information, identify speed information of the designated vehicle;
based on the first location, identify at least one external electronic device within a radius identified based on the speed information of the designated vehicle;
based on second video information obtained from the at least one external electronic device, identify the designated vehicle having the license plate indicating the designated character string;
based on identifying the designated vehicle, identify a second external electronic device obtaining video information including the designated vehicle from among the at least one external electronic device; and
based on a second location on which the second external electronic device is disposed and a timing at which the video information including the designated vehicle is obtained, identify a location of the designated vehicle.
